(19) United States
(12) Patent Application Publication
(10) Pub. No.: US 2020/0021991 A1
(43) Pub. Date: Jan. 16, 2020

(54) WI-FI DENIAL DEVICE

(71) Applicant: WhiteFox Defense Technologies, Inc., San Luis Obispo, CA (US)

(72) Inventors: LUKE FOX, SACRAMENTO, CA (US); RICHARD HOWE, ATASCADERO, CA (US); CALVIN BALKE, SAN LUIS OBISPO, CA (US); JIM DAVIS, SAN LUIS OBISPO, CA (US); WESLEY LILIENTHAL, SAN LUIS OBISPO, CA (US); TEYVON BROOKS, SAN LUIS OBISPO, CA (US)

(21) Appl. No.: 16/510,501

(22) Filed: Jul. 12, 2019

Related U.S. Application Data
(60) Provisional application No. 62/698,018, filed on Jul. 13, 2018.

(51) Int. Cl. H04W 12/08; H04W 12/00

(52) U.S. Cl. CPC H04W 12/0802; H04W 84/12; H04W 12/00512

(57) ABSTRACT

Systems and methods for a comprehensive, intuitive, ultra-compact, high-performance, low-impact, personnel efficient, non-jamming, and cost-effective targeted continuous Wi-Fi denial device are described. The Wi-Fi denial device receives communication from a Wi-Fi source, identifies the Wi-Fi device, compares the device to an authorized or unauthorized device list, and will disconnect the device if it is determined that the device is not on an authorized list of devices or on a list of unauthorized devices.

This application claims the benefit of U.S. Provisional Application No. 62/698,018, filed Jul. 13, 2018, for TARGETED CONTINUOUS WI-FI DENIAL DEVICE AND METHODS, which is incorporated in its entirety herein by reference.

### BACKGROUND OF THE INVENTION

### 1. Field of the Invention

The present invention relates generally to wi-fi denial, and more specifically to a targeted continuous wi-fi denial device.

### 2. Discussion of the Related Art

Various systems and processes are known in the art for targeted continuous wi-fi denial.

Wi-Fi is a group of radio technologies that are commonly used for wireless local area networking (WLAN). These radio technologies allow data to transfer wirelessly between devices. The most common use of Wi-Fi technology is providing Internet access to a range of devices.

Anyone within range of a Wi-Fi network may be able to attack a wireless network, causing Wi-Fi to be more vulnerable to attack than wired networks. Others may have the ability to intercept or interrupt your data if they are able to access the same wireless network. Denial of Service (DoS), an attack that floods the target, and an Evil Twin, a fraudulent Wi-Fi access point, are examples of common Wi-Fi attacking methods. The prevalence of these attacks warrants a device to protect Wi-Fi networks.

### SUMMARY

A device, system, method, and non-transitory computer readable medium for targeted continuous wi-fi denial are described. The device, system, method, and non-transitory computer readable medium provide for detecting a Wi-Fi device receiving communications from a Wi-Fi source, determining, based on Wi-Fi communications, an identity of the Wi-Fi device, comparing the identity of the Wi-Fi device to a list of unauthorized devices, disconnecting the Wi-Fi device from the Wi-Fi source when the identity of the Wi-Fi device is included in the list of unauthorized devices, comparing the identity of the Wi-Fi device to a list of authorized devices when the identity of the Wi-Fi device is not included in the list of unauthorized devices, and disconnecting the Wi-Fi device from the Wi-Fi source when the identity of the Wi-Fi device is not included in the list of authorized devices.

### BRIEF DESCRIPTION OF THE DRAWINGS

FIG. 1 shows an example of a side view, a bottom view and an end view of one embodiment of the Wi-Fi denial device in accordance with aspects of the present disclosure.

FIG. 2 shows an example of an exploded view of the Wi-Fi denial device in accordance with aspects of the present disclosure.

FIG. 3 shows an example of a schematic diagram of the internal components of the Wi-Fi denial device in accordance with aspects of the present disclosure.

FIG. 4 shows an example of a method for determining whether a device should be denied Wi-Fi service in accordance with aspects of the present disclosure.

FIGS. 5 through 6 show examples of a process for targeted continuous wi-fi denial in accordance with aspects of the present disclosure.

### DETAILED DESCRIPTION

The following description is not to be taken in a limiting sense but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

There are significant concerns with Wi-Fi networks that can be solved using a Wi-Fi denial device. Denying Wi-Fi access to all but a certain plurality of devices may allow a network to function at a reduced load, as well as reduce the chances of attacks from foreign devices.

The device described herein is a comprehensive, intuitive, ultra-compact, high-performance, low-impact, personnel efficient, non-jamming, and cost-effective targeted continuous Wi-Fi denial device. The Wi-Fi denial device detects Wi-Fi Internet of Things (IoT) devices even beyond visual line of sight (VLOS). The Wi-Fi denial device solves mission challenges such as counter-sUAS, counter-IED, and counter-surveillance.

In general, the Wi-Fi denial device generates a forensically unique fingerprint of each Wi-Fi device found within range of the denial device. This unique fingerprint is logged and enables future analysis such as determining device recurrence and other activity correlations. Users of the Wi-Fi denial device are able to safely, and continuously, target denial for any Wi-Fi-enabled device(s) such as: phones, drones/UAS, routers, IEDs, smart home systems, security cameras, etc. Each Wi-Fi denial device can simultaneously deny communication connections for up to 256 devices at a time. The Wi-Fi denial device supports whitelisting (ignore) and blacklisting (target) by three categories: individual device, manufacturer, and device category (e.g. drones and phones). This defensive continuous Wi-Fi denial device is produced in a form factor that is easily concealable on a person (e.g. pocket) or in any operating environment (e.g. city street planter).

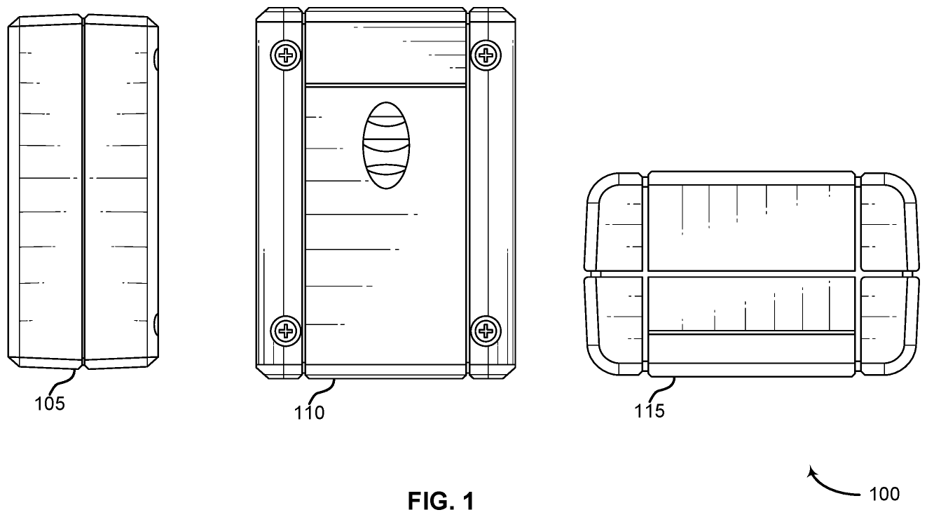

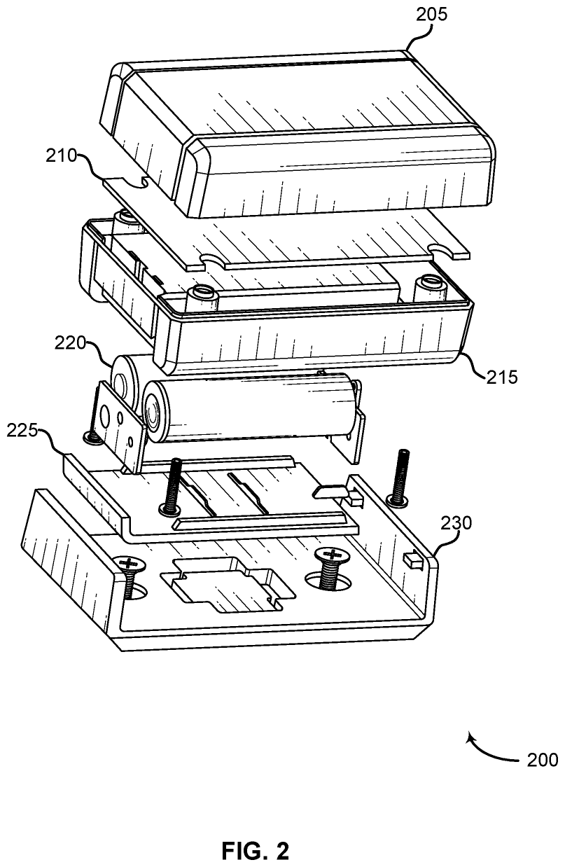

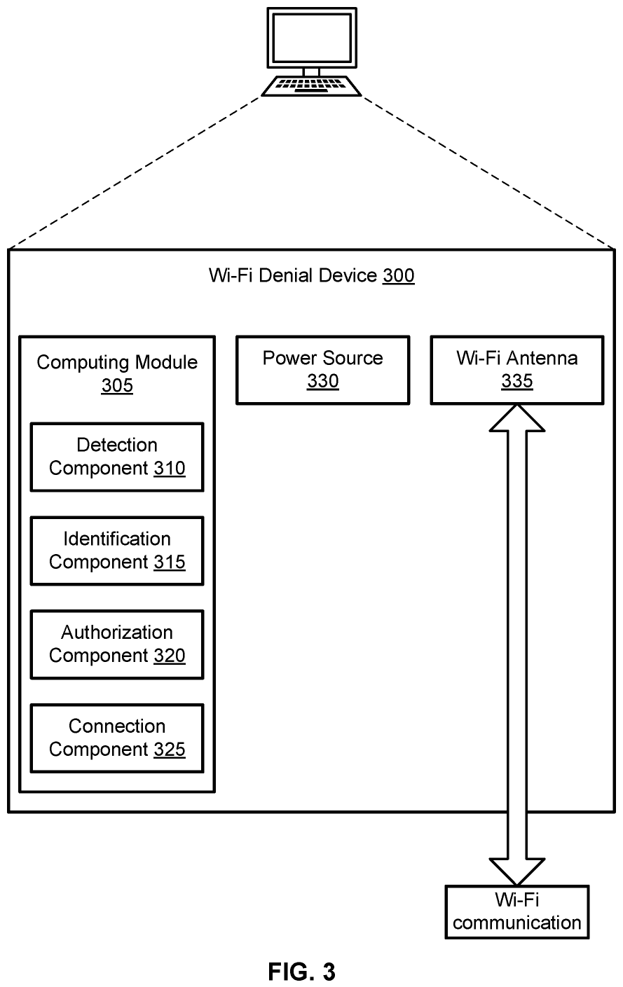

FIG. 1 shows an example of a side view 105, a bottom view 110 and an end view 115 of one embodiment of the Wi-Fi denial device 100 in accordance with aspects of the present disclosure. Wi-Fi denial device 100 may be an example of, or include aspects of, the corresponding element or elements described with reference to FIGS. 2 and 3.

The device is generally rectangular in shape, with a removable portion on the bottom part of the device for accessing the battery. In the present embodiment, the device dimensions are approximately 2.1 inches wide, 3 inches long, and 1.25 inches high.

FIG. 2 shows an example of an exploded view of the Wi-Fi denial device 200 in accordance with aspects of the present disclosure. Wi-Fi denial device 200 may be an example of, or include aspects of, the corresponding element or elements described with reference to FIGS. 1 and 3. Wi-Fi denial device 200 may include top casing 205, component mounting board 210, bottom casing 215, power source 220, battery cover 225, and mounting bracket 230.

The housing comprises the top casing 205 coupled to the bottom casing 215 to form the rectangular exterior shape with an interior space to hold the internal components. The battery cover 225 is removably coupled to the bottom casing 215. The power source 220 (batteries in this embodiment) is coupled to the bottom casing 215 and supplies power to the electrical components within the interior space. The component mounting board 210 is configured to mount internal components such as a PCB. The bottom housing, top housing and the battery cover 225 are typically comprised of epoxy. In some embodiments the power source 220 may be supplied via a USB connection. In the present embodiment, the Wi-Fi denial device is configured for at least 24 hours of continuous runtime.

In some embodiments the Wi-Fi denial device 200 includes additional components for user interface, for example, a display screen or a memory card with a config file stored on the memory card. In some embodiments the Wi-Fi denial device 200 includes additional components to provide user feedback, for example a display screen, one or more lights, or a vibration device.

FIG. 3 shows an example of a schematic diagram of the internal components of the Wi-Fi denial device 300 in accordance with aspects of the present disclosure. Wi-Fi denial device 300 may be an example of, or include aspects of, the corresponding element or elements described with reference to FIGS. 1 and 2.

The internal components include a computing module 305, a Wi-Fi antenna 335, and the power source 330 as previously described. The computing module 305 in one embodiment comprises at least one processor, memory as required for applications, storage, and other functions necessary for operation of the device. The computing module 305 also includes components necessary for Wi-Fi capabilities. For example, the computing module 305 may comprise an ESP32 system.

The internal components also include a semi-directional Wi-Fi antenna 335 coupled to the processor and configured to send and receive data over Wi-Fi. The Wi-Fi denial device 300 in the current embodiment is configured to send and receive data on 2.4 GHz and 5.8 GHz Wi-Fi bands.

Thus, Wi-Fi denial device 300 may include computing module 305, power source 330, and Wi-Fi antenna 335. Computing module 305 may include detection component 310, identification component 315, authorization component 320, and connection component 325.

Detection component 310 may detect a Wi-Fi device receiving communications from a Wi-Fi source. Identification component 315 may determine, based on Wi-Fi communications, an identity of the Wi-Fi device.

Authorization component 320 may compare the identity of the Wi-Fi device to a list of unauthorized devices. Authorization component 320 may also compare the identity of the Wi-Fi device to a list of authorized devices when the identity of the Wi-Fi device is not included in the list of unauthorized devices. Authorization component 320 may also access a blacklist data file to retrieve the list of unauthorized devices. Authorization component 320 may also access a whitelist data file to retrieve the list of authorized devices.

In some examples, the blacklist data file includes at least one of a group of blacklist identifiers including: a device ID for a specific Wi-Fi device, a Wi-Fi device model, a Wi-Fi device manufacturer, or a Wi-Fi device type and a Wi-Fi device categorization. In some examples, the whitelist data file includes at least one of a group of whitelist identifiers including: a device ID for a specific Wi-Fi device, a Wi-Fi device model, a Wi-Fi device manufacturer, or a Wi-Fi device type and a Wi-Fi device categorization.

In some examples, the blacklist data file includes at least one device ID for a specific Wi-Fi device. In some examples, the whitelist data file includes at least one device ID for a specific Wi-Fi device. In some examples, the blacklist data file includes at least one hash. In some examples, the whitelist data file includes at least one hash. In some examples, the determining includes generating a hash. In some examples, the comparing the identity of the Wi-Fi device to the list of unauthorized devices includes comparing the hash having been generated with the at least one hash in the blacklist data file. In some examples, the comparing the identity of the Wi-Fi device to the list of authorized devices includes comparing the hash having been generated with the at least one hash in the whitelist data file.

In some examples, the blacklist data file includes said at least one hash, where said at least one hash is generated as a function of at least one of beacon frame fields, subfields, vendor-specific fields, timing of packets, beacon intervals, power level, power level definition fields, modulation, bit-rate, and capability fields. In some examples, the whitelist data file includes said at least one hash, where said at least one hash is generated as a function of at least one of beacon frame fields, subfields, vendor-specific fields, timing of packets, beacon intervals, power level, power level definition fields, modulation, bit-rate, and capability fields. In some embodiments, the blacklist data file and/or the whitelist data files are generated as a function of at least two hashes of at least two of beacon frame fields, subfields, vendor-specific fields, timing of packets, beacon intervals, power level, power level definition fields, modulation, bit-rate, and capability fields.

In some examples, the determining includes generating a hash. In some examples, the comparing the identity of the Wi-Fi device to the list of unauthorized devices includes comparing the hash having been generated with the at least one hash in the blacklist data file. In some examples, the comparing the identity of the Wi-Fi device to the list of authorized devices includes comparing the hash having been generated with the at least one hash in the whitelist data file.

In some examples, accessing the blacklist data file includes accessing an operator removeable and replaceable data storage device. In some examples, accessing the whitelist data file includes accessing the operator removeable and replaceable data storage device.

In some examples, the operator removeable and replaceable storage device may be inserted through a slot in a housing. In some examples, the blacklist data file and the whitelist data file are stored on the operator removeable and replaceable data storage device. In some examples, the operator removeable and replaceable storage device is removeable and replaceable through a slot in a housing.

Connection component 325 may disconnect the Wi-Fi device from the Wi-Fi source when the identity of the Wi-Fi device is included in the list of unauthorized devices. Connection component 325 may also disconnect the Wi-Fi device from the Wi-Fi source when the identity of the Wi-Fi device is not included in the list of authorized devices.

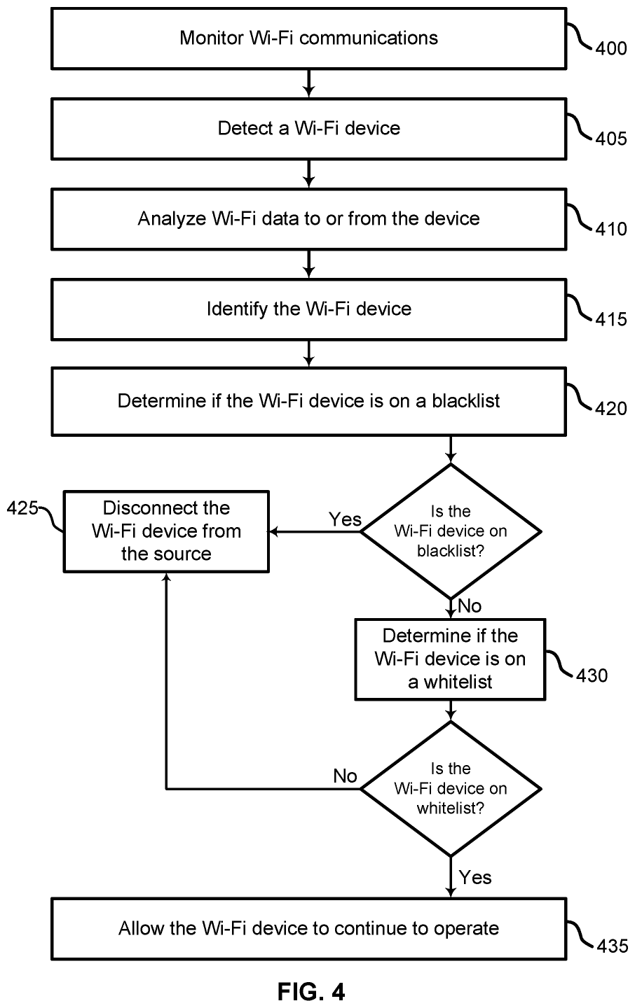

FIG. 4 shows an example of a method for determining whether a device should be denied Wi-Fi service in accordance with aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

As previously mentioned, the Wi-Fi denial device includes a whitelist of Wi-Fi devices that are allowed to operate and/or a blacklist of Wi-Fi devices to be denied or disallowed from operating. The Wi-Fi denial device may, for example, be communicatively coupled to a Wi-Fi hotspot, and direct the Wi-Fi hotspot to selectively deny or disconnect Wi-Fi devices in response to the Wi-Fi denial device. To identify the devices on the lists, the list can include a MAC address for each device, as well as at least one unique ID (or fingerprint) generated for each device.

The unique IDs (fingerprints) are generated as a function of Wi-Fi communication data and/or additional data that can be used to uniquely identify the Wi-Fi device when communications are received by the Wi-Fi denial device. Data that can be used to generate the unique IDs (fingerprints) includes a combination comprising one or more of beacon frame fields, subfields, vendor-specific fields, timing of packets, beacon intervals, power level, power level definition fields, modulation, bit-rate, and capability fields. The generated unique IDs (fingerprints) are saved in the whitelist or blacklist.

In one embodiment, one type of unique ID (fingerprint) can be generated by obtaining a plurality of the different types of Wi-Fi communication data (such as Wi-Fi communication data from the Wi-Fi device), hashing each type to determine a unique hash from each type of data, and creating the unique ID (fingerprint) by then hashing the combination of data hashes. Hashes can include SHA-256 and MD-5. In some embodiments the hash is optimized for low power. In another embodiment a unique ID (fingerprint) can be generated by taking specific frame data of the Wi-Fi device and using an anti-spoofing algorithm to generate the unique ID (fingerprint) that cannot be connected back to the original frame data. Another benefit of generating the unique IDs (fingerprints) is that the unique ID (fingerprint) may be a predetermined, fixed size, that requires less storage space.

In the method, first the Wi-Fi denial device monitors Wi-Fi communications. In the next step, the Wi-Fi denial device detects a Wi-Fi device through the Wi-Fi device's communication with a Wi-Fi source (such as a Wi-Fi hotspot) capable of two-way Wi-Fi communication. In the present embodiment, the elapsed time between sending of the Wi-Fi communication and reception by the Wi-Fi denial device is less than 2750 milliseconds. The Wi-Fi denial device is undetectable by other sources when operating in the passive, detect-only mode.

After detection, the Wi-Fi denial device receives the Wi-Fi communications from the Wi-Fi device and the Wi-Fi source and analyzes the data to and from the Wi-Fi device. The Wi-Fi denial device uses data included in the Wi-Fi communications to identify the Wi-Fi device. For example, as described above the Wi-Fi denial device can use the MAC addresses included in the transmitted frames, which identify the receiver and the transmitter, to check against the whitelist/blacklist.

Unique IDs (fingerprints) are generated for the Wi-Fi device using the same methods as were used to generate the whitelist/blacklist unique IDs. Based on the data, the Wi-Fi device is also categorized for one or more of the device types (e.g. drones, android phones or security cameras), the device manufacturer (e.g. DJI, GoPro, or Nest), or a device model (e.g. LEPD DJI Phantom 4 Pro).

Once the at least one unique ID (fingerprint) is generated for the Wi-Fi device, the Wi-Fi denial device compares the ID(s) to a blacklist. The blacklist may include device IDs for specific Wi-Fi devices, Wi-Fi device models, Wi-Fi device manufacturers, or Wi-Fi device types or other categorizations. In some cases, the blacklist may be set to include all Wi-Fi devices. The blacklist can be included in the Wi-Fi denial device prior to shipment. Additionally, or instead, the operator may add allowed devices to the blacklist. The blacklist can be reset/cleared.

If the Wi-Fi device is matched to the blacklist, the Wi-Fi device will be continuously denied communication connectivity to the source. In some embodiments, input is required from the operator before the Wi-Fi device is denied. In one embodiment, the Wi-Fi denial device sends communications to the Wi-Fi device directing the Wi-Fi device to cease communication with the source. Once the Wi-Fi device is denied communication, to allow the Wi-Fi device to regain connectivity, the Wi-Fi denial device needs to be out of range of the Wi-Fi device, or the Wi-Fi denial device powered off.

If the Wi-Fi device is not matched to the blacklist, the Wi-Fi denial device then compares the ID(s) to the whitelist. The whitelist may include unique IDs for specific Wi-Fi devices, Wi-Fi device models, Wi-Fi device manufacturers, or Wi-Fi device types or other categorizations. The whitelist can be included in the Wi-Fi denial device prior to shipment. Additionally, or instead, the operator may add allowed devices to the whitelist. The whitelist can be reset/cleared. The Wi-Fi denial device in some embodiments includes anti-spoofing technology to aid in preventing red force (enemy) devices from spoofing characteristics to mimic devices on the whitelist.

In one embodiment, in matching the device to the whitelist the Wi-Fi denial device first checks that the MAC address of the Wi-Fi device matches the whitelist. If the MAC address matches, it is still possible that the Wi-Fi device could be a different device than that identified by the MAC address, so additional checks using the unique ID(s) are typically warranted.

In some embodiments, a plurality of unique IDs is checked. If some but not all unique IDs match what is stored in the whitelist for a device, a weighted average of the comparison of unique IDs to whitelist IDs is generated. If the weighted average is above a certain threshold (i.e. the IDs indicate overall that the device does not match the whitelist), the Wi-Fi device is determined to not match the whitelist. If the weighted average is below the threshold, the device is determined to match the whitelist, and new unique ID(s) would be generated for the Wi-Fi device and added to the whitelist.

If the Wi-Fi device is matched to the whitelist, the Wi-Fi device will be allowed to be operated without interference by the Wi-Fi denial device. If the Wi-Fi device is not on the whitelist, the Wi-Fi device will be continuously denied communication connectivity as described above. In some embodiments, the Wi-Fi denial device is configured to send an alarm indication when the Wi-Fi device meets predetermined criteria.

In one embodiment, the unique ID for a Wi-Fi device is generated by hashing a plurality of predetermined data segments in the management frames to create the unique ID and storing the unique ID in a library. When the Wi-Fi device is encountered, the Wi-Fi denial device performs the same hash sequence on the management frames of the Wi-Fi device and compares it to what is stored in the library for that device. If a large portion of the hashed segments do not match the library, it may mean that the Wi-Fi device identity is not the same as that of the ID of the Wi-Fi device.

Thus, at step 400, the system monitors Wi-Fi communications. At step 405, the system detects a Wi-Fi device. At step 410, the system analyzes Wi-Fi data to or from the device. At step 415, the system identifies the Wi-Fi device.

At step 420, the system determines if the Wi-Fi device is on a blacklist. If the device is on the blacklist, at step 425, the system disconnects the Wi-Fi device from the Wi-Fi source. At step 430, the system determines if the Wi-Fi device is on a whitelist. If the device is not on the whitelist, at step 425, the system disconnects the Wi-Fi device from the Wi-Fi source. If the device is on the whitelist, at step 435, the system allows the Wi-Fi device to continue to operate on the Wi-Fi source.

Referring again to FIGS. 1-4, the Wi-Fi denial device has many applications for operators. For example, operators in a hostile environment may desire to control the Wi-Fi devices that are permitted to operate within a protection bubble around the Wi-Fi denial device.

In some embodiments, the Wi-Fi device may have the following characteristics: The Wi-Fi denial device may be able to detect a Wi-Fi device within 2750 milliseconds. The Wi-Fi denial device may be able to disconnect a Wi-Fi device within 1250 milliseconds. The Wi-Fi denial device has a range of up to 550 meters. The Wi-Fi denial device may operate using batteries (e.g. AA) or a 5V standard USB connection. The Wi-Fi denial device may include over 24 hours of runtime, with over 48 hours when operated in a power-saving mode. The Wi-Fi denial device may include a vibrating device to provide user feedback. The Wi-Fi denial device may be configured to store data on an SD card or other removable storage device. The Wi-Fi denial device may be configured to retrieve user setting from the SD card or other removable storage device. Activity logs may be stored on the SD card or other removable storage device. Weight of the device (without batteries) may be less than 5 ounces. Operating frequencies can include 2.4 GHz (2.400˜2.483 GHz) and 5.8 GHz (5.725 GHz˜5.875 GHz). The device can be configured to use approximately no power when detecting. When denying service, some embodiments may use less than 1.0W. Other embodiments may use less than 2.0W during denial.

Operators may need to gain knowledge of wireless Wi-Fi cameras or motion detection sensors being used in an environment and/or by an adversary. If sensors are detected, then before the operator enters the sensors' view, the Wi-Fi denial device can be activated with the sensor manufacturer blacklisted to deny communication between the sensors. For example, the Wi-Fi denial device would prevent the sensors from detecting the operator's activities while preparing for a tactical raid.

Operators can be called to a scene where a drone is flying unlawfully. The operator can attempt to engage the drone with a simple and cost-effective first line of defense solution.

The Wi-Fi denial device uses an algorithm to prevent Wi-Fi devices from communicating without jamming, interference, or collateral damage, i.e. creating a bubble of protection. The algorithm exploits an inherent vulnerability in the Wi-Fi standard, and thus cannot be patched. The Wi-Fi denial device has whitelist and blacklist modes (meaning only specific whitelisted devices/manufacturers/types can be explicitly permitted to communicate; or all but specific blacklisted devices/manufacturers/types are permitted to communicate). The Wi-Fi denial device works against any Wi-Fi Internet of Things (IoT) device such as Wi-Fi drones, phones, routers, Wi-Fi cameras, etc. Effective range has been tested and verified to 550 meters.

Whitelisting and blacklisting of specific devices are not susceptible to any form of spoofing, wherein a device pretends to be something that it is not. The adversary does so by simulating a device without actually being that device, thus potentially skirting blacklisting or effectively adding themselves to a whitelist. The Wi-Fi denial device whitelisting and blacklisting capabilities by manufacturer and by type is theoretically susceptible to sophisticated spoofing attacks by adversaries, although highly unlikely as it would require a significant amount of prior knowledge. For absolute security, specific devices should be whitelisted and blacklisted.

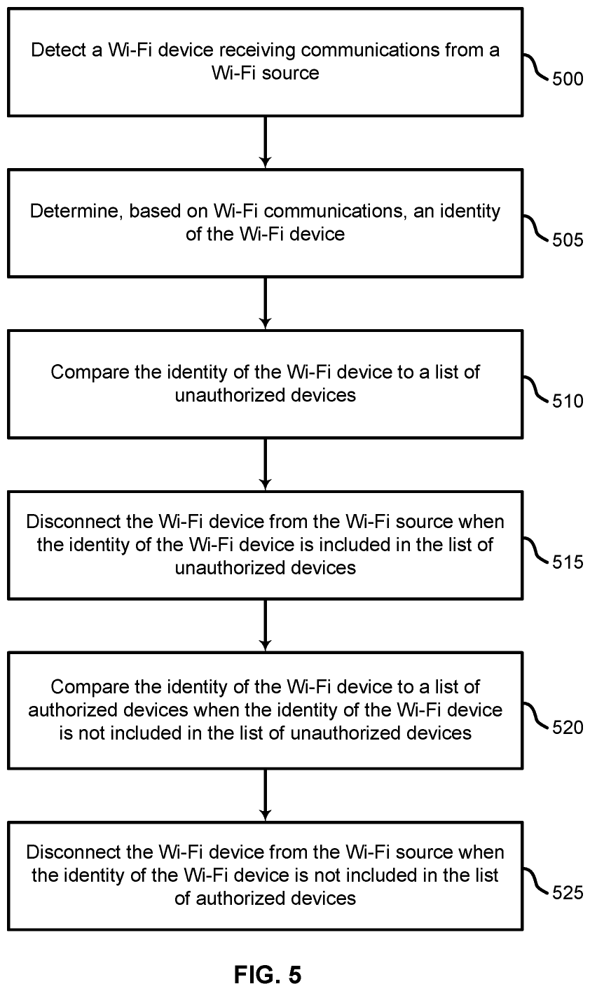

FIG. 5 shows an example of a process for targeted continuous wi-fi denial in accordance with aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 500, the system detects a Wi-Fi device receiving communications from a Wi-Fi source. In some cases, the operations of this step may refer to, or be performed by, a detection component as described with reference to FIG. 3.

At step 505, the system determines, based on Wi-Fi communications, an identity of the Wi-Fi device. In some cases, the operations of this step may refer to, or be performed by, an identification component as described with reference to FIG. 3.

At step 510, the system compares the identity of the Wi-Fi device to a list of unauthorized devices. In some cases, the operations of this step may refer to, or be performed by, an authorization component as described with reference to FIG. 3.

At step 515, the system disconnects the Wi-Fi device from the Wi-Fi source when the identity of the Wi-Fi device is included in the list of unauthorized devices. In some cases, the operations of this step may refer to, or be performed by, a connection component as described with reference to FIG. 3.

At step 520, the system compares the identity of the Wi-Fi device to a list of authorized devices when the identity of the Wi-Fi device is not included in the list of unauthorized devices. In some cases, the operations of this step may refer to, or be performed by, an authorization component as described with reference to FIG. 3.

At step 525, the system disconnects the Wi-Fi device from the Wi-Fi source when the identity of the Wi-Fi device is not included in the list of authorized devices. In some cases, the operations of this step may refer to, or be performed by, a connection component as described with reference to FIG. 3.

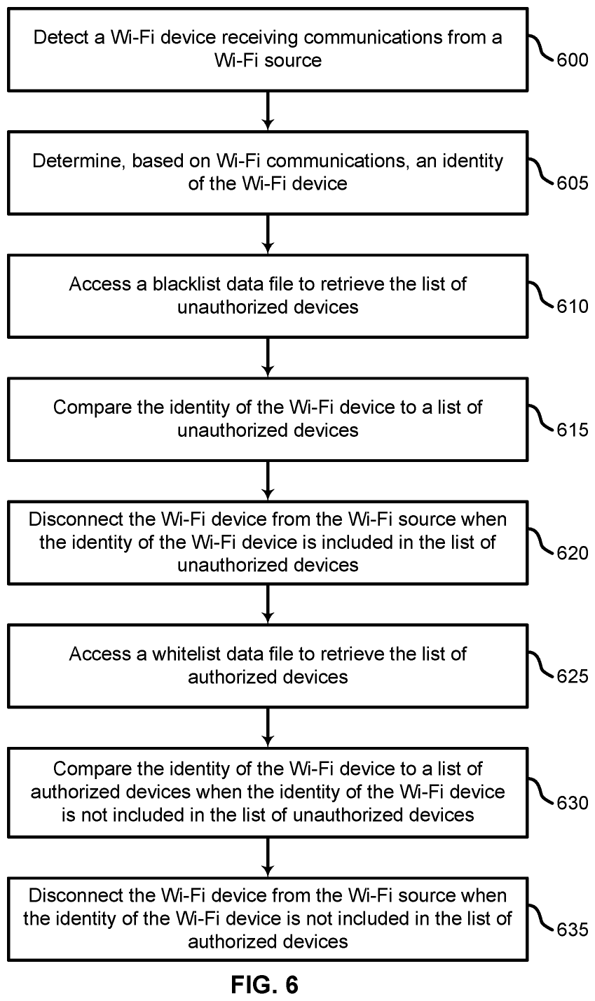

FIG. 6 shows an example of a process for targeted continuous wi-fi denial in accordance with aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 600, the system detects a Wi-Fi device receiving communications from a Wi-Fi source. In some cases, the operations of this step may refer to, or be performed by, a detection component as described with reference to FIG. 3.

At step 605, the system determines, based on Wi-Fi communications, an identity of the Wi-Fi device. In some cases, the operations of this step may refer to, or be performed by, an identification component as described with reference to FIG. 3.

At step 610, the system accesses a blacklist data file to retrieve the list of unauthorized devices. In some cases, the operations of this step may refer to, or be performed by, an authorization component as described with reference to FIG. 3.

At step 615, the system compares the identity of the Wi-Fi device to a list of unauthorized devices. In some cases, the operations of this step may refer to, or be performed by, an authorization component as described with reference to FIG. 3.

At step 620, the system disconnects the Wi-Fi device from the Wi-Fi source when the identity of the Wi-Fi device is included in the list of unauthorized devices. In some cases, the operations of this step may refer to, or be performed by, a connection component as described with reference to FIG. 3.

At step 625, the system accesses a whitelist data file to retrieve the list of authorized devices. In some cases, the operations of this step may refer to, or be performed by, an authorization component as described with reference to FIG. 3.

At step 630, the system compares the identity of the Wi-Fi device to a list of authorized devices when the identity of the Wi-Fi device is not included in the list of unauthorized devices. In some cases, the operations of this step may refer to, or be performed by, an authorization component as described with reference to FIG. 3.

At step 635, the system disconnects the Wi-Fi device from the Wi-Fi source when the identity of the Wi-Fi device is not included in the list of authorized devices. In some cases, the operations of this step may refer to, or be performed by, a connection component as described with reference to FIG. 3.

Accordingly, the present disclosure includes the following embodiments.

A Wi-Fi denial device is described. The device may include a network interface adapted to couple to a Wi-Fi source, a computing device coupled to the network interface, a Wi-Fi antenna coupled to the computing device, wherein the Wi-Fi denial device is configured to detect a Wi-Fi device receiving communications from a Wi-Fi source, determine, based on Wi-Fi communications, an identity of the Wi-Fi device, compare the identity of the Wi-Fi device to a list of unauthorized devices, disconnect the Wi-Fi device from the Wi-Fi source when the identity of the Wi-Fi device is included in the list of unauthorized devices, compare the identity of the Wi-Fi device to a list of authorized devices when the identity of the Wi-Fi device is not included in the list of unauthorized devices, and disconnect the Wi-Fi device from the Wi-Fi source when the identity of the Wi-Fi device is not included in the list of authorized devices.

A non-transitory computer readable medium storing code for targeted continuous wi-fi denial is described. In some examples, the code comprises instructions executable by a processor to: detect a Wi-Fi device receiving communications from a Wi-Fi source, determine, based on Wi-Fi communications, an identity of the Wi-Fi device, compare the identity of the Wi-Fi device to a list of unauthorized devices, disconnect the Wi-Fi device from the Wi-Fi source when the identity of the Wi-Fi device is included in the list of unauthorized devices, compare the identity of the Wi-Fi device to a list of authorized devices when the identity of the Wi-Fi device is not included in the list of unauthorized devices, and disconnect the Wi-Fi device from the Wi-Fi source when the identity of the Wi-Fi device is not included in the list of authorized devices.

A system for Wi-Fi denial is described. The system may include a computing device coupled to the network interface, a whitelist data file coupled to the computing device, a blacklist data file coupled to the computing device, and said computing device comprising logic for detecting a Wi-Fi device receiving communications from a Wi-Fi source, determining, based on Wi-Fi communications, an identity of the Wi-Fi device, comparing the identity of the Wi-Fi device to a list of unauthorized devices, disconnecting the Wi-Fi device from the Wi-Fi source when the identity of the Wi-Fi device is included in the list of unauthorized devices, comparing the identity of the Wi-Fi device to a list of authorized devices when the identity of the Wi-Fi device is not included in the list of unauthorized devices, and disconnecting the Wi-Fi device from the Wi-Fi source when the identity of the Wi-Fi device is not included in the list of authorized devices.

A method for targeted continuous wi-fi denial is described. The method may include detecting a Wi-Fi device receiving communications from a Wi-Fi source, determining, based on Wi-Fi communications, an identity of the Wi-Fi device, comparing the identity of the Wi-Fi device to a list of unauthorized devices, disconnecting the Wi-Fi device from the Wi-Fi source when the identity of the Wi-Fi device is included in the list of unauthorized devices, comparing the identity of the Wi-Fi device to a list of authorized devices when the identity of the Wi-Fi device is not included in the list of unauthorized devices, and disconnecting the Wi-Fi device from the Wi-Fi source when the identity of the Wi-Fi device is not included in the list of authorized devices.

Some examples of the device, non-transitory computer readable medium, system, and method described above may further include accessing a blacklist data file to retrieve the list of unauthorized devices. Some examples may further include accessing a whitelist data file to retrieve the list of authorized devices.

In some examples, the blacklist data file comprises at least one of a group of blacklist identifiers comprising: a device ID for a specific Wi-Fi device, a Wi-Fi device model, a Wi-Fi device manufacturer, or a Wi-Fi device type and a Wi-Fi device categorization. In some examples, the whitelist data file comprises at least one of a group of whitelist identifiers comprising: a device ID for a specific Wi-Fi device, a Wi-Fi device model, a Wi-Fi device manufacturer, or a Wi-Fi device type and a Wi-Fi device categorization.

In some examples, the blacklist data file comprises at least one device ID for a specific Wi-Fi device. In some examples, the whitelist data file comprises at least one device ID for a specific Wi-Fi device.

In some examples, the blacklist data file comprises at least one hash. In some examples, the whitelist data file comprises at least one hash. In some examples, the determining comprises generating a hash. In some examples, the comparing the identity of the Wi-Fi device to the list of unauthorized devices comprises comparing the hash having been generated with the at least one hash in the blacklist data file. In some examples, the comparing the identity of the Wi-Fi device to the list of authorized devices comprises comparing the hash having been generated with the at least one hash in the whitelist data file.

In some examples, the blacklist data file comprises said at least one hash, wherein said at least one hash is generated as a function of at least one of beacon frame fields, subfields, vendor-specific fields, timing of packets, beacon intervals, power level, power level definition fields, modulation, bit-rate, and capability fields. In some examples, the whitelist data file comprises said at least one hash, wherein said at least one hash is generated as a function of at least one of beacon frame fields, subfields, vendor-specific fields, timing of packets, beacon intervals, power level, power level definition fields, modulation, bit-rate, and capability fields.

In some examples, the blacklist data file comprises at least one hash, wherein the at least one hash is generated as a function of two or more hashes of at least two of beacon frame fields, subfields, vendor-specific fields, timing of packets, beacon intervals, power level, power level definition fields, modulation, bit-rate, and capability fields. In some examples, the whitelist data file comprises at least one hash, wherein said at least one hash is generated as a function of two or more hashes of at least two of beacon frame fields, subfields, vendor-specific fields, timing of packets, beacon intervals, power level, power level definition fields, modulation, bit-rate, and capability fields. In some examples, the determining comprises generating a hash. In some examples, the comparing the identity of the Wi-Fi device to the list of unauthorized devices comprises comparing the hash having been generated with the at least one hash in the blacklist data file. In some examples, the comparing the identity of the Wi-Fi device to the list of authorized devices comprises comparing the hash having been generated with the at least one hash in the whitelist data file.

In some examples, the blacklist data file comprises accessing an operator removeable and replaceable data storage device. In some examples, the whitelist data file comprises accessing the operator removeable and replaceable data storage device.

Some examples of the device, non-transitory computer readable medium, system, and method described above may further include inserting the operator removeable and replaceable storage device through a slot in a housing.

In some examples, the blacklist data file and the whitelist data file are stored on the operator removeable and replaceable data storage device. In some examples, the operator removeable and replaceable storage device is removeable and replaceable through a slot in a housing.

While the invention herein disclosed has been described by means of specific embodiments, examples and applications thereof, numerous modifications and variations could be made thereto by those skilled in the art without departing from the scope of the invention set forth in the claims.

What is claimed is:

1. A Wi-Fi denial device comprising:
a network interface adapted to couple to a Wi-Fi source;
a computing device coupled to the network interface;
a Wi-Fi antenna coupled to the computing device, wherein the Wi-Fi denial device is configured to perform the steps of:
detect a Wi-Fi device receiving communications from a Wi-Fi source;
determine, based on intercepted Wi-Fi communications, an identity of the Wi-Fi device;
compare the Wi-Fi device identity to a list of unauthorized devices;
when the Wi-Fi device identity is included in the list of unauthorized devices, disconnect the Wi-Fi device from the Wi-Fi source;
when the Wi-Fi device identity is not included in the list of unauthorized devices, compare the Wi-Fi device to a list of authorized devices; and
when the Wi-Fi device identity is not included in a list of authorized devices, disconnect the Wi-Fi device from the Wi-Fi source.

2. The Wi-Fi denial device of claim 1 further comprising:
a blacklist data file coupled to the computing device; and
a whitelist data file coupled to the computing device.

3. The Wi-Fi denial device of claim 2 further comprising:
said blacklist data file, wherein said blacklist data file comprises at least one of a group of blacklist identifiers comprising: a device ID for a specific Wi-Fi device, a Wi-Fi device model, a Wi-Fi device manufacturer, or a Wi-Fi device type and a Wi-Fi device categorization; and
said whitelist data file, wherein said whitelist data file comprises at least one of a group of whitelist identifiers comprising: a device ID for a specific Wi-Fi device, a Wi-Fi device model, a Wi-Fi device manufacturer, or a Wi-Fi device type and a Wi-Fi device categorization.

4. The Wi-Fi denial device of claim 2 further comprising:
said blacklist data file, wherein said blacklist data file comprises at least one device ID for a specific Wi-Fi device; and
said whitelist data file, wherein said whitelist data file comprises at least one device ID for a specific Wi-Fi device.

5. The Wi-Fi denial device of claim 4 further comprising:
said blacklist data file, wherein said blacklist data file comprises at least one hash; and
said whitelist data file, wherein said whitelist data file comprises at least one hash.

6. The Wi-Fi denial device of claim 5 further comprising:
said blacklist data file, wherein said blacklist data file comprises said at least one hash, wherein said at least one hash is generated as a function of at least one of beacon frame fields, subfields, vendor-specific fields, timing of packets, beacon intervals, power level, power level definition fields, modulation, bit-rate, and capability fields; and
said whitelist data file, wherein said whitelist data file comprises said at least one hash, wherein said at least one hash is generated as a function of at least one of beacon frame fields, subfields, vendor-specific fields, timing of packets, beacon intervals, power level, power level definition fields, modulation, bit-rate, and capability fields.

7. The Wi-Fi denial device of claim 4 further comprising:
said blacklist data file, wherein said blacklist data file comprises at least one hash, wherein the at least one hash is generated as a function of two or more hashes of at least two of beacon frame fields, subfields, vendor-specific fields, timing of packets, beacon intervals, power level, power level definition fields, modulation, bit-rate, and capability fields; and
said whitelist data file, wherein said whitelist data file comprises at least one hash, wherein the at least one hash is generated as a function of two or more hashes of at least two of beacon frame fields, subfields, vendor-specific fields, timing of packets, beacon intervals, power level, power level definition fields, modulation, bit-rate, and capability fields.

8. The Wi-Fi denial device of claim 4 further comprising:
an operator removable and replaceable data storage device, wherein the blacklist data file and the whitelist data file are stored on the operator removeable and replaceable data storage device.

9. The Wi-Fi denial device of claim 8 further comprising:
said operator removeable and replaceable data storage device, wherein said operator removeable and replaceable storage device is removeable and replaceable through a slot in a housing.

10. A method for Wi-Fi denial comprising:
detecting a Wi-Fi device receiving communications from a Wi-Fi source;
determining, based on Wi-Fi communications, an identity of the Wi-Fi device;
comparing the identity of the Wi-Fi device to a list of unauthorized devices;
disconnecting the Wi-Fi device from the Wi-Fi source when the identity of the Wi-Fi device is included in the list of unauthorized devices;
comparing the identity of the Wi-Fi device to a list of authorized devices when the identity of the Wi-Fi device is not included in the list of unauthorized devices; and
disconnecting the Wi-Fi device from the Wi-Fi source when the identity of the Wi-Fi device is not included in the list of authorized devices.

11. The method of claim 10 further comprising:
accessing a blacklist data file to retrieve the list of unauthorized devices; and
accessing a whitelist data file to retrieve the list of authorized devices.

12. The method of claim 11 further comprising:
accessing said blacklist data file, wherein said blacklist data file comprises at least one of a group of blacklist identifiers comprising: a device ID for a specific Wi-Fi device, a Wi-Fi device model, a Wi-Fi device manufacturer, or a Wi-Fi device type and a Wi-Fi device categorization; and
accessing said whitelist data file, wherein said whitelist data file comprises at least one of a group of whitelist identifiers comprising: a device ID for a specific Wi-Fi device, a Wi-Fi device model, a Wi-Fi device manufacturer, or a Wi-Fi device type and a Wi-Fi device categorization.

13. The method of claim 12 further comprising:
accessing said blacklist data file, wherein said blacklist data file comprises at least one device ID for a specific Wi-Fi device; and
accessing said whitelist data file, wherein said whitelist data file comprises at least one device ID for a specific Wi-Fi device.

14. The method of claim 13 further comprising:
accessing said blacklist data file, wherein said blacklist data file comprises at least one hash;
accessing said whitelist data file, wherein said whitelist data file comprises at least one hash;
said determining, wherein said determining comprises generating a hash;
said comparing the identity of the Wi-Fi device to the list of unauthorized devices, wherein said comparing the identity of the Wi-Fi device to the list of unauthorized devices comprises comparing the hash having been generated with the at least one hash in the blacklist data file; and
said comparing the identity of the Wi-Fi device to the list of authorized devices, wherein said comparing the identity of the Wi-Fi device to the list of authorized devices comprises comparing the hash having been generated with the at least one hash in the whitelist data file.

15. The method of claim 14 further comprising:
accessing said blacklist data file, wherein said blacklist data file comprises said at least one hash, wherein said at least one hash is generated as a function of at least one of beacon frame fields, subfields, vendor-specific fields, timing of packets, beacon intervals, power level, power level definition fields, modulation, bit-rate, and capability fields; and
accessing said whitelist data file, wherein said whitelist data file comprises said at least one hash, wherein said at least one hash is generated as a function of at least one of beacon frame fields, subfields, vendor-specific fields, timing of packets, beacon intervals, power level, power level definition fields, modulation, bit-rate, and capability fields.

16. The method of claim 13 further comprising:
said blacklist data file, wherein said blacklist data file comprises at least one hash, wherein the at least one hash is generated as a function of two or more hashes of at least two of beacon frame fields, subfields, vendor-specific fields, timing of packets, beacon intervals, power level, power level definition fields, modulation, bit-rate, and capability fields;
said whitelist data file, wherein said whitelist data file comprises at least one hash, wherein said at least one hash is generated as a function of two or more hashes of at least two of beacon frame fields, subfields, vendor-specific fields, timing of packets, beacon intervals, power level, power level definition fields, modulation, bit-rate, and capability fields;
said determining, wherein said determining comprises generating a hash;
said comparing the identity of the Wi-Fi device to the list of unauthorized devices, wherein said comparing the identity of the Wi-Fi device to the list of unauthorized devices comprises comparing the hash having been generated with the at least one hash in the blacklist data file; and
said comparing the identity of the Wi-Fi device to the list of authorized devices, wherein said comparing the identity of the Wi-Fi device to the list of authorized devices comprises comparing the hash having been generated with the at least one hash in the whitelist data file.

17. The method of claim 13 further comprising:
said accessing said blacklist data file comprising accessing an operator removeable and replaceable data storage device; and
said accessing said whitelist data file comprising accessing the operator removeable and replaceable data storage device.

18. The method of claim 17 further comprising:
inserting the operator removeable and replaceable storage device through a slot in a housing.

19. A system for Wi-Fi denial comprising:
a network interface adapted to couple to a Wi-Fi source;
a computing device coupled to the network interface;
a whitelist data file coupled to the computing device;
a blacklist data file coupled to the computing device;
said computing device comprising logic for performing the following steps:
detecting a Wi-Fi device receiving communications from the Wi-Fi source;
determining, based on Wi-Fi communications, an identity of the Wi-Fi device;
comparing the identity of the Wi-Fi device to a list of unauthorized devices;
disconnecting the Wi-Fi device from the Wi-Fi source when the identity of the Wi-Fi device is included in the list of unauthorized devices;
comparing the identity of the Wi-Fi device to a list of authorized devices when the identity of the Wi-Fi device is not included in the list of unauthorized devices; and
disconnecting the Wi-Fi device from the Wi-Fi source when the identity of the Wi-Fi device is not included in the list of authorized devices.

20. The system of claim 19 further comprising:
said blacklist data file, wherein said blacklist data file comprises at least one of a group of blacklist identifiers comprising: a device ID for a specific Wi-Fi device, a Wi-Fi device model, a Wi-Fi device manufacturer, or a Wi-Fi device type and a Wi-Fi device categorization; and
said whitelist data file, wherein said whitelist data file comprises at least one of a group of whitelist identifiers comprising: a device ID for a specific Wi-Fi device, a Wi-Fi device model, a Wi-Fi device manufacturer, or a Wi-Fi device type and a Wi-Fi device categorization.

21. The system of claim 20 further comprising:
said blacklist data file, wherein said blacklist data file comprises at least one device ID for a specific Wi-Fi device; and
said whitelist data file, wherein said whitelist data file comprises at least one device ID for a specific Wi-Fi device.

22. The system of claim 21 further comprising:
said blacklist data file, wherein said blacklist data file comprises at least one hash; and
said whitelist data file, wherein said whitelist data file comprises at least one hash.

23. The system of claim 22 further comprising:
said blacklist data file, wherein said blacklist data file comprises said at least one hash, wherein said at least one hash is generated as a function of at least one of beacon frame fields, subfields, vendor-specific fields, timing of packets, beacon intervals, power level, power level definition fields, modulation, bit-rate, and capability fields; and
said whitelist data file, wherein said whitelist data file comprises said at least one hash, wherein said at least one hash is generated as a function of at least one of beacon frame fields, subfields, vendor-specific fields, timing of packets, beacon intervals, power level, power level definition fields, modulation, bit-rate, and capability fields.

24. The system of claim 21 further comprising:
said blacklist data file, wherein said blacklist data file comprises at least one hash, wherein the at least one hash is generated as a function of two or more hashes of at least two of beacon frame fields, subfields, vendor-specific fields, timing of packets, beacon intervals, power level, power level definition fields, modulation, bit-rate, and capability fields; and
said whitelist data file, wherein said whitelist data file comprises at least one hash, wherein said at least one hash is generated as a function of two or more hashes of at least two of beacon frame fields, subfields, vendor-specific fields, timing of packets, beacon intervals, power level, power level definition fields, modulation, bit-rate, and capability fields.

25. The system of claim 21 further comprising:
an operator removable and replaceable data storage device, wherein the blacklist data file and the whitelist data file are stored on the operator removeable and replaceable data storage device.

26. The system of claim 25 further comprising:
said operator removeable and replaceable data storage device, wherein the operator removeable and replaceable storage device is removeable and replaceable through a slot in a housing.
